(19) United States
(12) Patent Application Publication
(10) Pub. No.: US 2026/0304282 A1
(43) Pub. Date: Oct. 1, 2026

(54) REPORTING OF URSP RULE ENFORCEMENT AT A UE

(71) Applicant: GOOGLE LLC, Mountain View, CA (US)

(72) Inventors: Ching-yu Liao, Mountain View, CA (US); Pavan Nuggehalli, Mountain View, CA (US)

(21) Appl. No.: 19/478,797

(22) PCT Filed: Apr. 26, 2024
(86) PCT No.: PCT/US2024/026688

§ 371 Date: Oct. 24, 2025

Related U.S. Application Data
(60) Provisional application No. 63/498,520, filed on Apr. 26, 2023.

(51) Int. Cl. H04W 40/04; H04W 60/00

(52) U.S. Cl. CPC H04W 40/04; H04W 60/00

(57) ABSTRACT

To route application traffic, a user equipment (UE) initiates (1930), for the application traffic, an enforcement of a UE route selection policy (URSP) rule; receives (1932), from a core network (CN), a reporting trigger indication corresponding to the URSP rule; and reports (1941), to the CN and in accordance with the reporting trigger indication, the enforcement of the URSP rule.

### CROSS-REFERENCE TO RELATED APPLICATIONS

This application claims priority to and the benefit of the filing date of provisional U.S. Patent Application Ser. No. 63/498,520 entitled “METHOD OF UE REPORTING FOR URSP RULE ENFORCEMENT,” filed on Apr. 26, 2023. The entire contents of the provisional application are hereby expressly incorporated herein by reference.

### FIELD OF THE DISCLOSURE

This disclosure relates generally to wireless communications and, more particularly, to reporting the application of rules for routing application traffic at a user device.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In wireless communication systems, a user equipment (UE) can apply a UE Route Selection Policy (URSP) to outgoing traffic to determine how the UE should route traffic for a certain application executing on an operating system (OS), a certain domain, a certain network host, etc. A URSP rule may include (1) a rule precedence value, (2) one or more traffic descriptors (TDs), and/or (3) one or more route selection descriptors (RSDs). Rule precedence values determine the order in which the UE applies the URSP rules, traffic descriptors specify how the UE should match outgoing traffic to the rule to determine whether the rule applies, and route selection descriptors specify how the UE should route the traffic if the rule applies.

For example, according to a first URSP rule, a UE should route traffic related to network domain D to the already-established Protocol Data Unit (PDU) session; according to a second URSP rule, the UE should establish a new PDU session for outgoing traffic addressed to host H; and according to a third URSP rule, the UE should offload all Ethernet traffic to a wireless local area network (WLAN) such as a Wi-Fi network. If the first rule in this example has a higher rule precedence value than the second rule, the UE should apply the first rule rather than the second rule to the outgoing traffic that matches the respective traffic descriptors of the first and second rules (i.e., the traffic relates to domain D and is addressed to host H).

A UE can locally store pre-provisioned URSP rules and also receive URSP rules from the core network (CN). When the UE has both pre-provisioned rules and CN-specified rules, the UE may apply the CN-specified rules.

It is not yet clear how and when a UE should notify the network that the UE enforces a URSP rule for certain traffic. In particular, there is no clearly defined trigger for reporting URSP rule enforcement from a UE to the network. If, for example, the UE were to report connection capabilities simply when the UE enforced a URSP rule that includes connection capabilities (CC) for a traffic descriptor (TD), this type of reporting would produce a large amount of signaling overhead and increase energy consumption at the UE.

Further, in situations when a UE receives a list of URSP rules (e.g., in a single UE policy container), it is not clear whether the UE should report URSP rule enforcement for the list or any time the UE enforces an individual URSP rule included in the list. Meanwhile, the Policy Control Function (PCF) in the core network would need to maintain a list of URSP rules the UE enforces to configure and update the UE policy accordingly.

Still further, one or more network functions in a core network may not support URSP rule enforcement reporting. Reporting URSP rule enforcement to the CN in these situations results in wasted network resources.

### SUMMARY

An example embodiment of the techniques of this disclosure is a method for routing application traffic, implemented in a user equipment (UE). The method comprises initiating, for the application traffic, an enforcement of a UE route selection policy (URSP) rule; receiving, from a core network (CN), a reporting trigger indication corresponding to the URSP rule; and reporting, to the CN and in accordance with the reporting trigger indication, the enforcement of the URSP rule.

Another example embodiment of the techniques is a method for routing application traffic. The method is implemented in a core network (CN) of a cellular communication system and comprises transmitting, to a user equipment (UE), a reporting trigger indication corresponding to a UE route selection policy (URSP) rule stored at the UE; and receiving, from the UE and in accordance with the reporting trigger indication, a report of enforcement of the URSP rule.

Yet another example embodiment of the techniques is a device comprising processing hardware and configured to implement one of the methods above.

### BRIEF DESCRIPTION OF THE DRAWINGS

FIG. 1 is a block diagram of an example communication system in which a user equipment (UE) can report enforcement of a UE route selection policy (URSP) rule to a core network (CN) according to a reporting trigger indication;

FIG. 2 is a block diagram of an example URSP rule which the UE of FIG. 1 can enforce;

FIG. 3 is a service-based representation of the CN architecture, which the system of FIG. 1 can implement;

FIG. 4 is a reference-point based representation of the CN architecture, which the system of FIG. 1 can implement;

FIG. 5 illustrates an example procedure for creating and/or modifying a packet data unit (PDU) session between a UE and core network;

FIG. 6 is a messaging diagram of an example scenario in which a CN transmits, to a UE, a reporting trigger for URSP rule enforcement;

FIG. 7 is a messaging diagram of an example scenario in which a CN transmits, to a UE, a reporting trigger for URSP rule enforcement and an indication of network support of URSP rule enforcement reporting;

FIG. 8 is a messaging diagram of an example scenario similar to that of FIG. 7, but in which the CN transmits the indication of network support of URSP rule enforcement reporting in a downlink (DL) non-access stratum (NAS) message along with a UE policy container, rather than in an registration accept message;

FIG. 9 is a flow diagram of an example method for reporting URSP rule enforcement based on whether there is a reporting trigger indication for the URSP rule, which can be implemented in the UE of FIG. 1;

FIG. 10 is a flow diagram of an example method for reporting URSP rule enforcement based on whether there is a reporting trigger indication for the URSP rule, and whether the CN indicated support of URSP rule enforcement reporting, which can be implemented in the UE of FIG. 1;

FIG. 11 is a flow diagram of an example method generally similar to that of FIG. 10, but with the CN indicating support of URSP rule enforcement reporting during a UE configuration update procedure rather than in a registration accept message;

FIG. 12 is a flow diagram of an example method for configuring, for a UE, a URSP rule with an indication of URSP rule enforcement reporting, which can be implemented in the CN of FIG. 1;

FIG. 13 is a flow diagram of an example method for processing a URSP rule with an indication of URSP rule enforcement reporting, which can be implemented in the UE of FIG. 1;

FIG. 14 is a flow diagram of an example method for processing a URSP rule with an implicit indication of URSP rule enforcement reporting, which can be implemented in the UE of FIG. 1;

FIG. 15 is a flow diagram of an example method for processing a URSP rule with one or more validation criteria for URSP rule enforcement reporting, which can be implemented in the UE of FIG. 1;

FIG. 16 is a flow diagram of an example method for providing a list of Policy Section Identifier (PSIs) for which the UE is to perform URSP rule enforcement reporting, which can be implemented in the CN of FIG. 1;

FIG. 17 is a flow diagram of an example method for specifying URSP rule reporting for individual PSIs, which can be implemented in the CN of FIG. 1;

FIG. 18 is a flow diagram of an example method for determining whether to report URSP rule enforcement based on a PSI, which can be implemented in the of FIG. 1;

FIG. 19 is a flow diagram of an example method for processing application traffic, which can be implemented in the UE of FIG. 1; and

FIG. 20 is a flow diagram of an example method for routing application traffic, which can be implemented in the CN of FIG. 1.

### DETAILED DESCRIPTION OF THE DRAWINGS

To manage reporting of UE route selection policy (URSP) rule enforcement to a core network (CN), a UE determines whether the UE stores, or has received, a reporting trigger indication corresponding to the URSP rule. In some implementations, the network also indicates support or non-support of URSP rule enforcement reporting, so that the UE reports the URSP rule enforcement only when there is a reporting trigger indication as well as support at the CN, e.g., at the Policy Control Function (PCF). The CN implements the corresponding functionality to provide a reporting trigger indication and/or a network reporting support indication, and to process the URSP rule enforcement reporting.

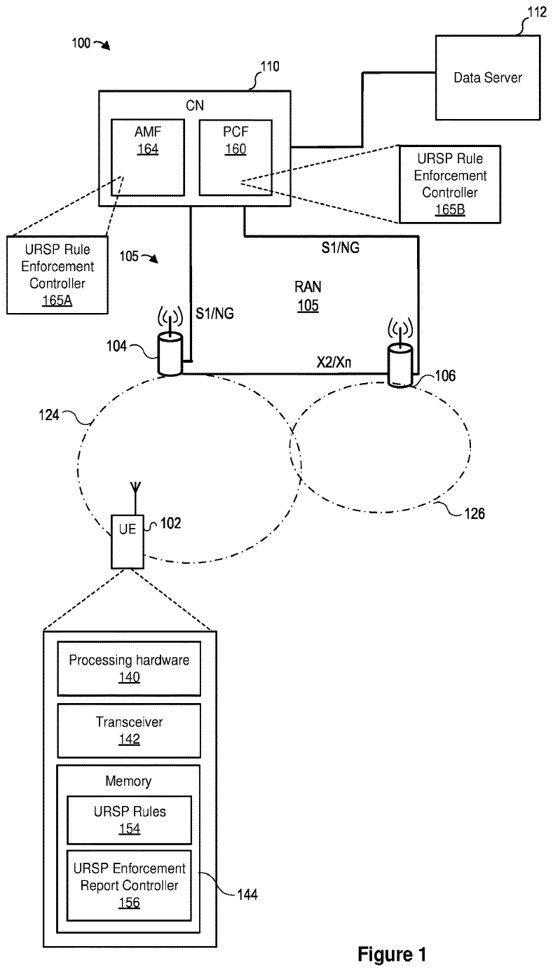

FIG. 1 illustrates an example communication system 100 in which the reporting techniques of this disclosure can be implemented. The communication system 100 includes a user equipment (UE) 102, which can be any suitable device capable of wireless communications with a core network (CN) 110 via a base station 104. A data server 112 can communicate data with the UE 102, in a downlink or uplink direction, via the CN 110.

Generally speaking, the UE 102 can determine that certain traffic descriptors associated with rules that specify route selection for outgoing traffic at the UE 102 are proscribed (or “forbidden”), and that the UE 102 should not use these proscribed descriptors when matching the outgoing traffic to the rules. Although the disclosure refers primarily to URSP rules, these techniques also can apply to other rule-based routing mechanisms. The UE 102 can determine that a rule includes a proscribed traffic descriptor and subsequently ignore the rule when applying the set of rules of an URSP. As another example, the UE 102 can determine that a rule contains both proscribed and non-proscribed, or permissible, traffic descriptors. The UE 102 then can apply the rule by ignoring the proscribed traffic descriptors and using only the permissible traffic descriptors for matching the outgoing traffic.

Further, the UE 102 can be allowed to prioritize a local configuration over URSP rules received from the CN 110. For instance, the UE 102 can apply local rules over those rules that include proscribed traffic descriptors or can prioritize a local set of rules in its entirety over the URSP rules received from the CN 110.

Still further, the UE 102 can preemptively request that the CN 110 not supply the UE 102 with any URSP rules that include the proscribed traffic descriptors. For example, the UE 102 can determine that a certain traffic descriptor is proscribed and transmit a corresponding indication to the CN 110. To this end, the UE 102 can use an existing protocol for managing URSP rules or use a dedicated message for indicating proscribed traffic descriptors.

The UE also can combine at least some of these techniques. For example, if the UE 102 transmits an indication of a proscribed traffic descriptor to the CN 110, but the CN 110 nevertheless responds with URSP rules containing proscribed traffic descriptors (for example, due to a race condition or because the CN 110 does not support the message from the UE 102), the UE 102 can apply the other techniques discussed above to prevent application of any rules that contain forbidden traffic descriptors. As another example, the UE 102 can ignore rules that reference only proscribed traffic descriptors, but still apply rules that reference both proscribed and permissible traffic descriptors by utilizing only the permissible traffic descriptors. In at least some of the implementations, the UE 102 can consider the rules that reference one or more proscribed traffic descriptors as inapplicable.

As illustrated in FIG. 1, the base station 104 is communicatively connected to a core network (CN) 110 via an NG interface, for example. In some implementations, the base station 104 is a 5G New Radio (NR) base station operating as a g Node B (gNB), and the CN 110 is a 5G core network (5GC). In other implementations, however, the communication system 100 can include one or more base stations that operate according to radio access technologies (RATs) of types other than NR, and these base stations can be connected to CNs of other types. Further, in some implementations, the UE 102 also has direct access via a radio interface to other types of access networks, such as a wireless local area network WLAN (via an access point (AP), for example).

The base station 104 is associated with a RAN 105 and provides coverage to a cell 124. Although FIG. 1 depicts the base station 104 as associated with only one cell 124, it is understood that the base station 104 in some implementations also covers one or more additional cells not shown in FIG. 1. Further, the RAN 105 can include any suitable number of base stations that collectively support one or more RATs. For example, the RAN 105 can include a base station 106 that provides coverage to a cell 126. The UE 102 can communicatively connect with the RAN 105 via the base station 104 when operating within cell 124, and in turn can communicatively connect with the CN 110 via the RAN 105.

The UE 102 is equipped with processing hardware 140, which can include one or more general-purpose processors (e.g., CPUs) and at least one non-transitory computer-readable memory 144 storing instructions executable on the one or more general processors and/or special-purpose processing units. The memory 144 stores an operating system (OS) of the UE 102, which can be any type of suitable mobile or general-purpose operating system. In addition, in some implementations, the memory 144 also stores one or more applications (neither the OS nor the applications are shown to avoid clutter). In operation, the one or more applications generate outgoing traffic and receive incoming traffic. These applications can include web browsers, mailing applications, messaging applications, video and audio players, gaming applications, etc.

To communicate with the base station 104, the CN 110, and various remote hosts, the UE 102 implements a communication protocol stack that includes an upper layer and an NAS/URSP handling layer. These layers can be implemented using any suitable combination of hardware, software, and firmware. In one example implementation, these layers are a set of instructions that the processing hardware 130 executes to perform the rule application techniques discussed herein.

The upper layer can identify outgoing traffic at the UE and provide outgoing traffic to the NAS/URSP handling layer for routing. The NAS/URSP handling layer can be a combined layer including both a NAS layer and a URSP handling layer. The NAS layer can manage the establishment and maintenance of communication sessions, such as protocol data unit (PDU) sessions. Further, the NAS layer can receive URSP rules from the CN 110 and configure the URSP handling layer with the received URSP rules. The combined NAS/URSP handling layer can manage the application of rules for routing outgoing traffic at the UE 102, as described in further detail below. When the upper layer determines that an application executing on the UE 102 has queued outgoing data for transmission, the upper layer can direct the NAS/URSP handling layer to apply one or more URSP rules and route the outgoing application traffic accordingly.

The memory 144 can store URSP rules 154, some or all of which the UE 102 can receive from the CN 110, and some or all of which the UE 102 pre-store in a persistent portion of the memory 144. The memory 144 in an example implementation includes a UE rule enforcement report controller (not shown) configured to manage or control application of rules for routing outgoing traffic and prevent application of proscribed traffic descriptors, and a URSP enforcement report controller 156 configured to report the enforcement of one or more of the URSP rules 154.

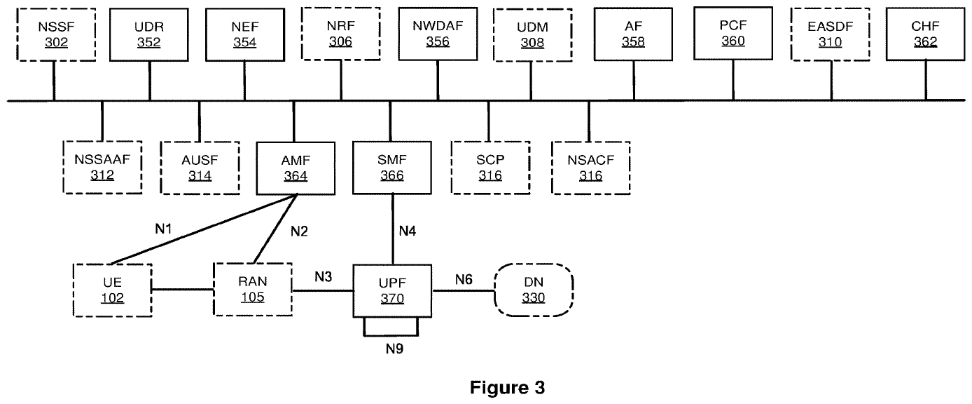

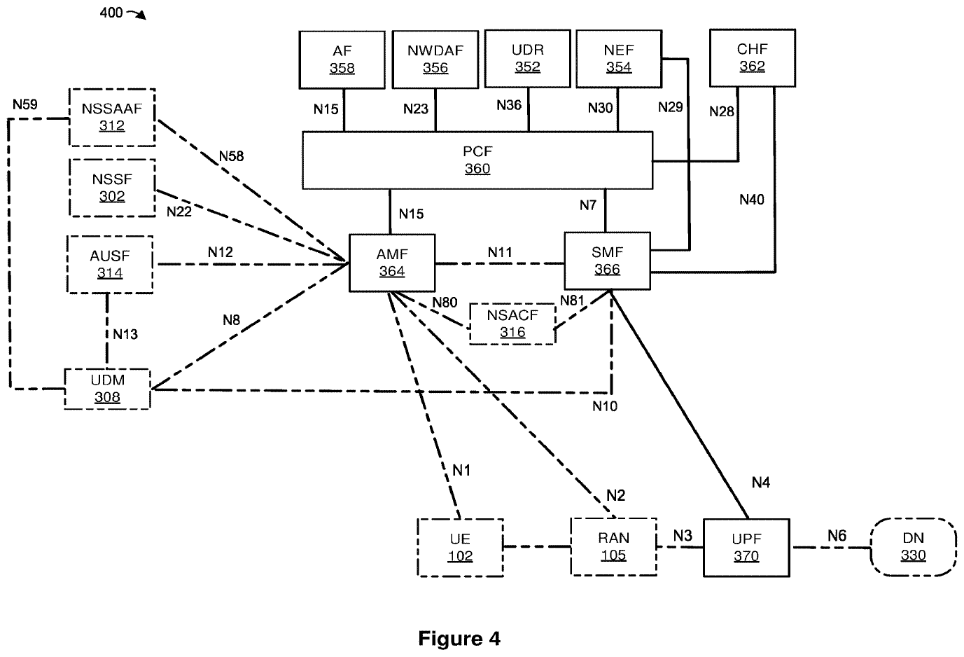

The CN 110 can be, for example, a 5G core network (5GC), a less advanced core network (e.g., an evolved packet core (EPC)) or, conversely, a more advanced core network. The CN 110 in some implementations is equipped with a mobility management entity such as Access and Mobility Management Function (AMF) 164 configured to manage authentication, registration, mobility, and other related functions, and a policy control entity such as Policy Control Function (PCF) 160 for providing policies for mobility and session management. An example implementation of the CN 110 is discussed in more detail with reference to FIGS. 3 and 4.

The CN 110 also, in some implementations, includes a URSP rule enforcement controller 165A operating in the AMF 164, and a URSP rule enforcement controller 165B operating in the PCF 160. The

With continued reference to FIG. 1, the CN 110 communicatively connects UE 102, via the RAN 105 including the base station 104 (and typically multiple other base stations), to various communication networks including a wide area network such as the Internet. More specifically, the CN 110 can directly connect to a data network (DN) via an access point name (APN) or data network name (DNN) gateway. The UE 102 can include outgoing traffic with a traffic descriptor that identifies the gateway, and the CN 110 can provide a rule that references the gateway. When the UE 102 determines that the traffic descriptor referencing the gateway is permissible, the UE 102 applies the rule and routes the outgoing traffic in accordance with the rule. Otherwise, when the UE 102 determines that the traffic descriptor referencing the gateway is proscribed, the UE 102 ignores the rule, modifies the rule, or otherwise processes the rule in accordance with the techniques of this disclosure. In some example scenarios, outgoing traffic and/or one or more rules can reference the data server 112.

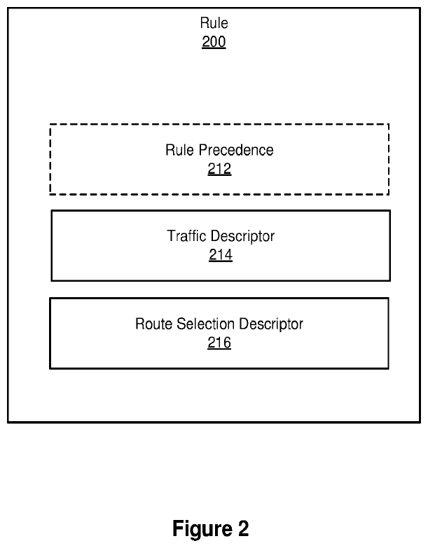

FIG. 2 is a block diagram of an example rule 200 for route selection which the UE 102 of FIG. 1 can apply to outgoing traffic to determine how the UE 102 should route outgoing traffic. A route selection policy, such as a URSP received from CN 110 or a local configuration stored at the UE 102, includes one or more rules that conform to the format of FIG. 2. The example rule 200 includes a rule precedence 212, a traffic descriptor 214, and a route selection descriptor 216. In general, depending on the implementation rules include one or more traffic descriptors and one or more route selection descriptors.

The rule precedence field 212 specifies the order in which the UE 102 applies the rule 200 relative to other rules. In some implementations, the rule precedence 212 of each rule is different from the rule precedence of every other rule within the URSP. Traffic descriptors specify how the UE 102 should match outgoing traffic to the rule. For example, if the traffic descriptor 214 of rule 200 matches the parameters of outgoing traffic, then the UE 102 would apply rule 200 to the outgoing traffic. In some implementations, a URSP includes a rule with lowest precedence that has a “match all” traffic descriptor that UE 102 can apply to any outgoing traffic.

Traffic descriptors include, for example, application identifiers of applications 142 executing on the OS 140 of the UE 102. As another example, traffic descriptors also correspond to IP descriptors such as an IP destination and/or an IP 3 tuple including destination IP address or IPv6 network, port number, and protocol ID. In some implementations, traffic descriptors are also non-IP descriptors such as descriptors for Ethernet traffic. In some implementations, a traffic descriptor refers to a specific type of network traffic. Further, as discussed above, traffic descriptors in some implementations correspond to an APN or DNN gateway. In further implementations, traffic descriptors also correspond to various connection capabilities of the UE 102, such as IP Multimedia Subsystem (IMS) capabilities, Multimedia Message Service (MMS) capabilities, or other internet-related capabilities. In still further implementations, traffic descriptors are domain descriptors such as a domain name, a hostname, or a fully qualified domain name (FQDN) made up of a domain name and a hostname.

The route selection descriptor 214 specifies how the UE 102 should route the traffic if the rule applies. In some examples, the route selection descriptor 216 specifies that the UE 102 should route traffic matching the traffic descriptor 214 of the rule 200 to an already-established communication session, such as an established Protocol Data Unit (PDU) session. As another example, the route selection descriptor 216 instructs the UE 102 to establish a new PDU session for outgoing traffic matching the rule 200. As yet another example, the route selection descriptor 216 instructs the UE 102 to offload outgoing traffic matching the rule 200 to a wireless local area network (WLAN) such as a Wi-Fi network.

In an example scenario, a URSP includes three rules. In some implementations, rule R₁ has a rule precedence of 1 and a traffic descriptor corresponding to application identifier App₁. In further implementations, rule R₂ has a rule precedence of 2 and traffic descriptor corresponding to application identifier App₂. In still further implementations, rule R₃ has a rule precedence of 3 and traffic descriptor corresponding to the “match all” option. When the UE 102 has outgoing traffic, the UE 102 evaluates the rules in the order of rule precedence. Thus, the UE 102 in this scenario first determines whether it should apply rule R₁ to the outgoing traffic by determining whether the outgoing traffic matches the traffic descriptor of rule R₁ (i.e., if the outgoing traffic corresponds to traffic of App₁). If the outgoing traffic corresponds to traffic of App₁, the UE 102 applies rule R₁ to the outgoing traffic and routes the traffic in accordance with the one or more route selection descriptors of rule App₁. If the outgoing traffic does not match the traffic descriptor of rule R₁, the UE 102 determines whether it should apply rule R₂, and so on.

FIG. 3 is a service-based representation 300 of an example CN architecture, which the CN 110 of FIG. 1 for example can implement. In the representation 300, the overall non-roaming reference architecture of the policy and charging control (PCC) framework for the 5GS includes components illustrated using solid lines, and the other components are illustrated using dashed lines. According to this representation, network functions enable other authorized network functions to access their services. The components that are outside the PCC framework include a Network Slicing Selection Function (NSSF) 302, a Network Repository Function (NRF) 306, a Unified Data Management (UDM) 308, an Edge Application Server Discovery Function (EASDF) 310, a Network Slice Specific Authentication and Authorization Function (NSSAAF) 312, an Authentication Server Function (AUSF) 314, a Service Communication Proxy (SCP) 316, and a Network Slice Admission Control Function (NSACF) 318. The non-PCC architecture further includes the UEs 102A and 102B, the PINEs 108A and 108B, and the (R)AN 105.

The PCC framework in the architecture 300 includes a Unified Data Repository (UDR) 352, a Network Exposure Function (NEF) 354, a network data analytics function (NWDAF) 356, an Application Function (AF) 358, a Policy Control Function (PCF) 360, a Charging Function (CHF) 362, an Access & Mobility Management Function (AMF) 364, a Session Management Function (SMF) 366, and a User Plane Function (UPF) 370.

The AMF 364 is generally configured to manage registration, connection, and mobility of a UE (such as the UE 102A or 102B) and provide transport for session management (SM) messages between the UE 102A or 102B and the SMF 366. In some implementations, the AMF 364 is configured to generate logical interface IDs, as will be described below in detail.

The SMF 366 is generally configured to manage sessions, allocate IP addresses for UEs, and provides downlink (DL) notifications. The UDM 308 is generally configured to handle user identification, access authorization based on subscription data, and subscription management. In some implementations, the UDM 308 is configured to generate or change logical interface IDs, as will be described below in detail. In some implementations, the UDM 308 supports the functionality of PIN group management handling.

The UDR 352 is generally configured to store subscription-related information, such as subscription data, policy data, structured data for exposure, and application data. In some implementations, the UDR 352 is configured to store PIN communication configuration information, as will be described below in detail. The UPF 370 is generally configured to handle packet routing and forwarding. In some implementations, the UPF 370 includes a functionality of supporting PDR configuration with a packet filter set for the PIN. The NEF 354 is generally configured to expose a network's capabilities and services to authorized third-party applications.

The AF 358 in some deployment operates in a trusted domain or outside the trusted domain, i.e., in a non-trusted domain. The trusted domain is generally internal to the CN 110 and includes such components as the UDM 308, the UDR 352, the PCF 360, the AMF 364, the SMF 366, and the UPF 370. Generally speaking, an AF operating outside the trusted domain (such as operated by an authorized third-party entity) can access the network functions of the CN 110 only via the NEF 354, whereas an AF operating within the trusted domain can access at least some of the network functions of the CN 110 directly, or may access these functions via the NEF 354 in some deployments.

The UE 102A or the AF 358 may provide QoS flow parameters to the CN 110.

FIG. 4 is a reference-point based representation 400 of an example 5GS architecture. In FIG. 4, the non-roaming reference architecture of the PCC framework for the 5GS is illustrated as blocks and connections with solid lines, and components and connections outside the PCC framework are illustrated using dashed lines.

The communication system shown FIGS. 1-4 in may include additional, fewer, and/or alternative devices or functionalities, and may be configured to perform additional, fewer, or alternate actions, including functionalities/actions described herein.

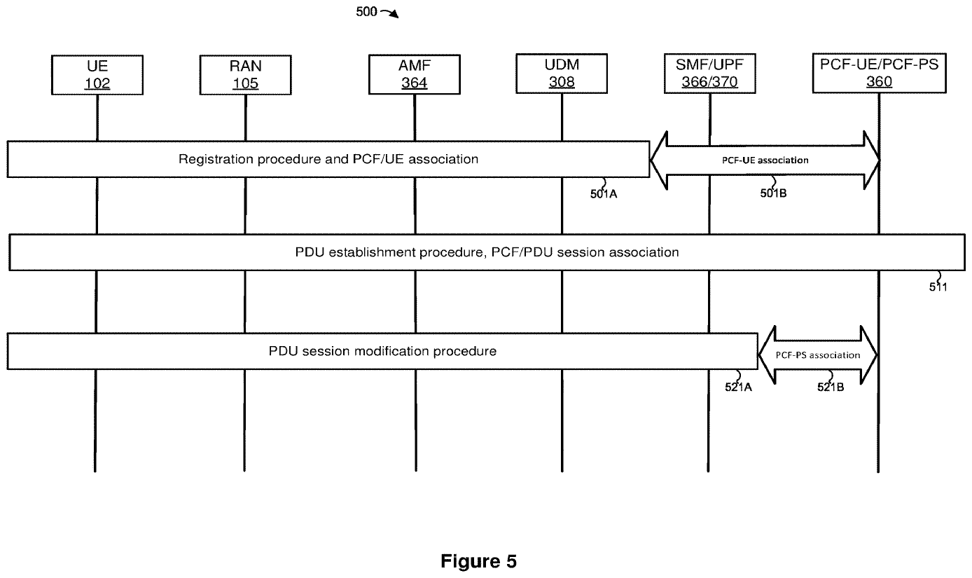

Next, FIG. 5 illustrates a scenario 500 including high-level procedures a UE and a 5G network perform to register the UE, receive UE policy from the 5G network, and establish a PDU session based on UE policy provisioned at the 5G network.

In particular, the UE 102 performs 501A registration request procedure, which cane be based on TS23.502 clause 4.2.2.2. The AMF 364 may select a PCF-UE 360 and create 501B a PCF-UE association.

The PCF-UE 360 can perform 511 a UE Configuration Update procedure to provision SM UE policies, which can be implemented as described in TS23.502, clause 4.2.4.3.

The UE 102 can perform 521A a PDU Session Establishment/Modification request procedure according to TS23.502 clause 4.3.2, for example. The SMF 366 can select a PCF-PS and create 521B a PCF-PS association to retrieve and/or update SM UE policies of the PDU Session.

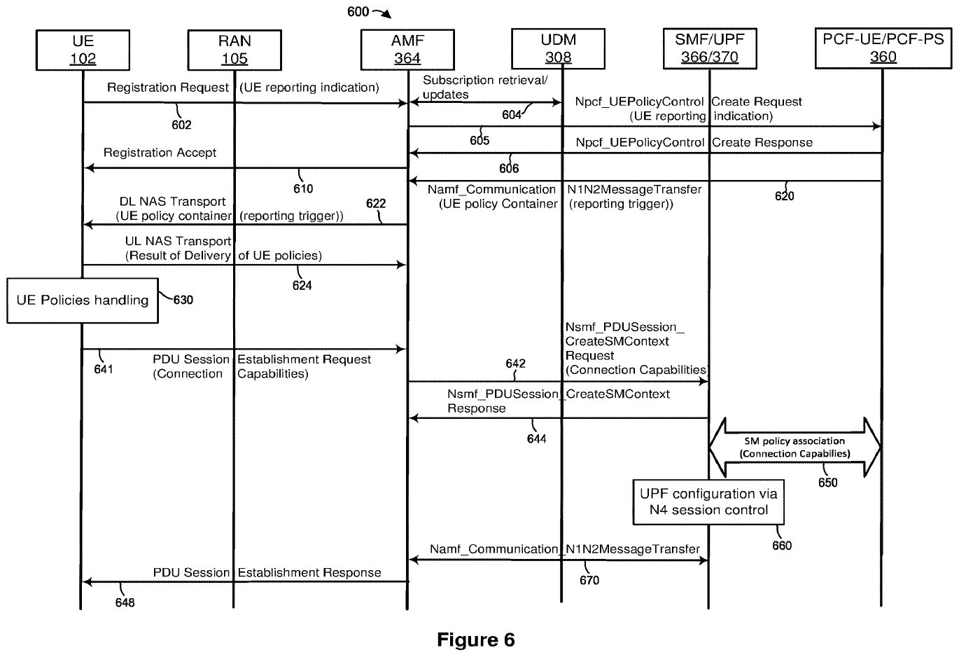

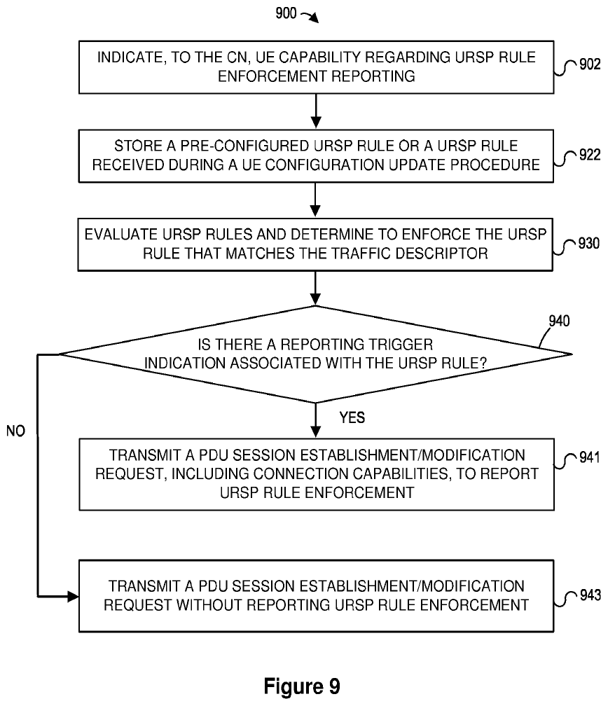

Next, several example techniques for reporting URSP rule enforcement are discussed with reference to the messaging diagrams of FIGS. 6-8 and the flow diagrams of FIGS. 9-20. Generally speaking, similar events in FIGS. 6-20 are labeled with the similar reference numbers that share two least significant digits, with the relevant differences discussed below where appropriate. For example, event 602 is similar to events 702 and 802, event 630 is similar to event 730 and 803, and block 1002 is similar to block 1102.

Referring first to FIG. 6, the CN 110 in an example scenario 600 transmits, to the UE 102, a reporting trigger for URSP rule enforcement. The UE 102 transmits 602, to the AMF 364, a Registration Request message including an indication of UE capabilities with respect to reporting URSP rules enforcement. The AMF 364 stores 604 an indication of the UE capabilities for reporting URSP rules enforcement.

The AMF 364 selects a PCF-UE (in this example, the PCF 360) and creates 605, 606 a PCF-UE association for the UE 102 to handle and control UE policies. More specifically, the AMF 364 transmits 605 an Npcf_UEPolicyControl Create Request message including the SUPI of the UE 102 and an indication of the UE capability for reporting URSP rule enforcement to the associated PCF-UE. The AMF 364 receives 606 an Npcf_UEPolicyControl Create Response message from the PCF-UE 360 to confirm the PCF-UE association for UE policy control. The AMF 364 then transmits 610 a Registration Accept message to the UE 102.

The PCF-UE 360 triggers a UE Configuration Update Procedure (which can be implemented similar to TS 23.502 clause 4.2.4.3) and transmits 620, to the AMF 364, an Namf_Communication_NIN2MessageTransfer message including a UE policy container, which in turn includes UE policy information. The reporting trigger is provided as an explicit or implicit indication in UE policy container.

The UE 102 receives 622, from the AMF 364, a DL NAS Transport message including the UE policy container with UE policy information. The AMF 364 can provide the reporting trigger as an explicit or implicit indication in the UE policy container. The UE 102 responds 624 with a UL NAS Transport message indicating the result of UE policies delivery. The UE 102 can store the UE policies in the local memory.

Next, the UE 102 performs 630 UE policies handling with URSP rules. More specifically, the UE 102 can evaluate the URSP rules, determine to enforce an URSP rule that matches the traffic descriptor (TD) of the URSP rule, and determine whether to report URSP rules enforcement based on the reporting trigger indication associated with the enforced URSP rule. The UE 102 in some scenarios applies pre-configured URSP rules and, in other implementations, applies the URSP rules the UE 102 receives 622 from the CN 110.

When the UE 102 detects a reporting trigger indication associated with the enforced URSP rule, the UE 102 transmits 641 a PDU Session Establishment/Modification request message including connection capabilities (CC), as reporting information, to the SMF 366, via the AMF 364 using a Nsmf_PDUSession_CreateSMcontext request message, which includes the CC. The AMF 364 forwards 642 the report to the SMF 366 and receives 644 a response.

The SMF 366 creates 650 a PCF-PS association and transmits the CC the UE 102 reported, to the PCF-UE 360 via the PCF-PS. The SMF 366 then configures 660 one or more UPFs using N4 Session control, for traffic routing and QoS control. The SMF 366 and the AMF 364 respond 670, 648, to the UE 102, via an Namf_Communication_NIN2MessageTransfer message and a PDU Session Establish/Modification Response message, respectively.

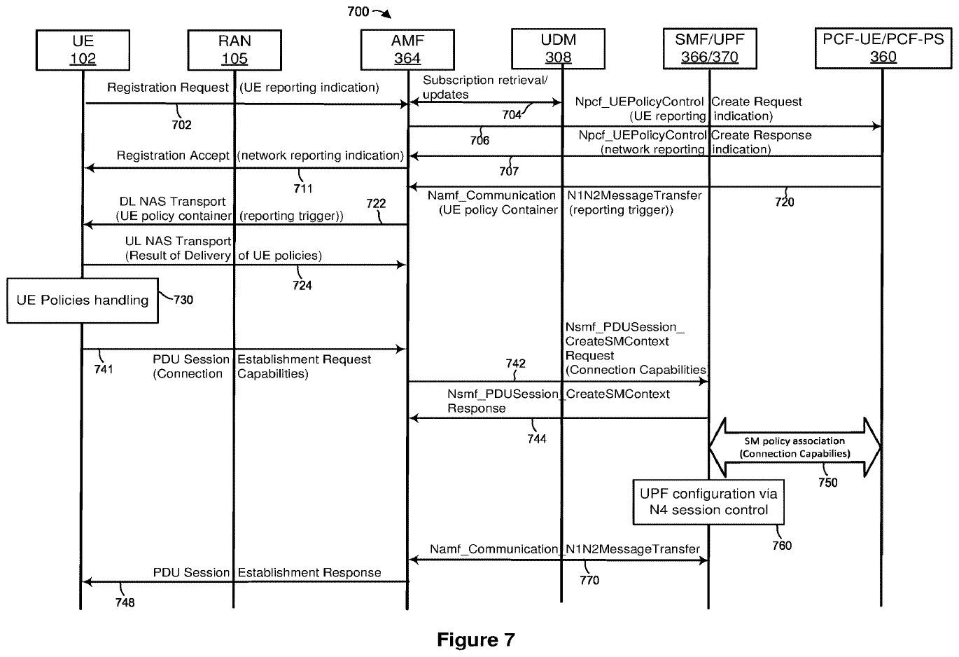

FIG. 7 is a messaging diagram of an example scenario 700 in which the CN transmits 110, to the UE 102, a reporting trigger for URSP rule enforcement and an indication of network support of URSP rule enforcement reporting.

The scenario 700 is generally similar to the scenario 600, e.g., events 702, 704, 720, etc. are similar to the events 602, 604, 620, etc. Here, however, the PCF-UE 360 transmits 706, to the AMF 364, an Npcf_UEPolicyControl Create Response message that includes an URSP rule reporting support indication, when confirming the PCF-UE association for UE policy control. The AMF 364 transmits 711, to the UE 102, a Registration Accept message including the URSP rule reporting support indication. The UE 102 can store the URSP rule reporting support indication. The remaining events 741, 742, 744, etc. are similar to the corresponding events in the scenario 600.

Because the associated PCF-UE can change, the AMF 364 may subscribe to event exposure of the associated PCF-UE for the change of URSP rule reporting support. In an example implementation, when the associated PCF-UE changes, and the support of the URSP rule reporting changes at the new PCF-UE, the AMF 364 receives an update of URSP rule reporting support from the new associated PCF-UE. Further, the AMF 364 can determine whether to include a URSP rule reporting support indication in the Registration Accept message next time the UE 102 performs a Registration Request procedure.

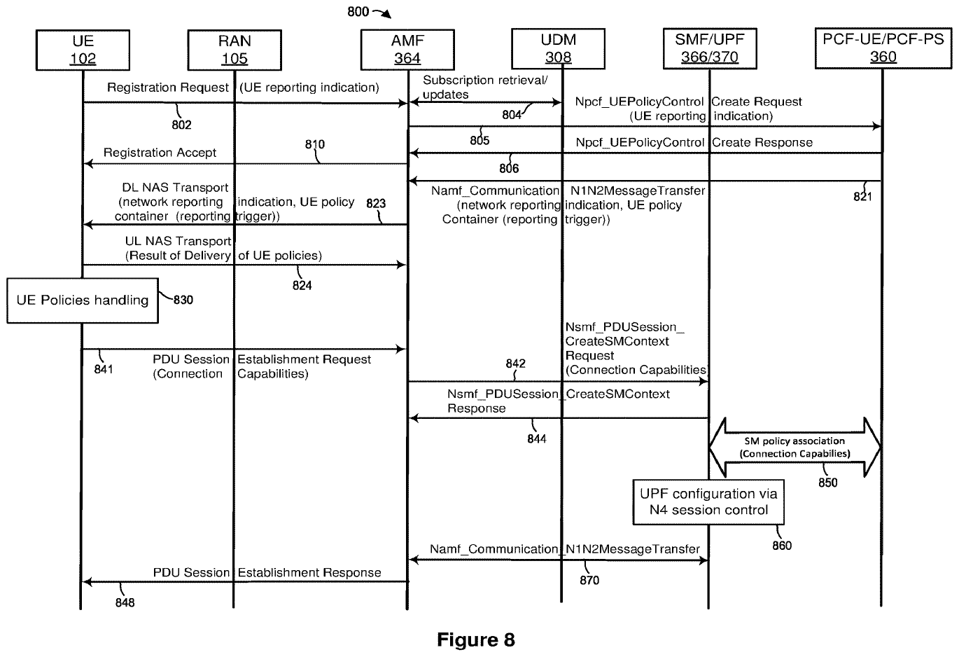

Now referring to FIG. 8, an example scenario 800 is generally similar to the scenario 700, but here the CN 110 transmits the indication of network support of URSP rule enforcement reporting in a downlink (DL) non-access stratum (NAS) message along with a UE policy container, rather than in a registration accept message.

The scenario 800 is also generally similar to the scenario 600, and events 802, 804, 805, 806, and 810 are similar to the events 602, 604, 605, 606, and 610, respectively.

However, here the PCF-UE 360 triggers a UE Configuration Update Procedure to transmit 821, to the AMF 364, a reporting trigger (which can be an explicit or implicit indication in the UE policy container) and also transmit a URSP rule reporting support indication. In one implementation, the UE policy container in the event 821 includes an URSP rule reporting support indication as well as UE policy information to the UE. In another implementation, the UE policy container in the event 821 includes UE policy information, and the Namf_Communication_NIN2MessageTransfer message includes a URSP rule reporting support indication (in other words, the URSP rule reporting support indication and the UE policy container are both elements the Namf_Communication_NIN2MessageTransfer message).

The AMF 364 transmits 823, to the UE 102, a DL NAS Transport message including UE policy container that contains UE policy information. The DL NAS Transport message also includes a URSP rule reporting support indication, which can be a dedicated IE (specifically defined for the purpose of indicating URSP rule reporting support) along with a UE policy container. Alternatively, the UE policy container can include the URSP rule reporting support indication. Further, the DL NAS Transport message can include a reporting trigger indication, which can be an explicit or implicit indication. The reporting trigger indication also can be an element in the UE policy container.

The UE 102 can respond 824 with a UL NAS Transport message indicating the result of UE policies delivery. The UE 102 also can store the UE policies. If the UE 102 stores the URSP rule reporting support indication, the UE 102 can determine 830 whether to report URSP rules enforcement based on reporting trigger indication associated with the enforced URSP rule.

Because the associated PCF-UE can change, the PCF-UE may trigger a UE Configuration Update procedure and determine whether to send a URSP rule reporting support indication to the UE 102. In one implementation, the PCF-UE transmits a UE policy container including a URSP rule reporting support indication, along with UE policy information, to the UE 102. In another implementation, the PCF-UE transmits a URSP rule reporting support indication along with a UE policy container including the UE policy information to the UE 102.

FIG. 9 is a flow diagram of an example method 900 for reporting URSP rule enforcement based on whether there is a reporting trigger indication for the URSP rule, which can be implemented in the UE 102 or in another suitable UE. In particular, the UE 102 reports URSP rule enforcement based on the capabilities of the UE 102 and the information from the CN 110.

At block 902, the UE 102 indicates its capabilities with respect to reporting URSP rules enforcement, in a registration request message during the registration request procedure (see, e.g., event 602 in FIG. 6). For example, if the UE 102 as the capabilities to support reporting of URSP rules enforcement, the UE 102 includes a positive indication.

At block 922, the UE 102 receives UE policy information including network-provisioned URSP rules, via a UE Configuration Update procedure (see, e.g., event 622 in FIG. 6). When the UE 102 receives a UE policy from the network, the UE 102 stores the URSP rules.

Next, at block 930, the UE 102 evaluates the URSP rules and determines to enforce a URSP rule that matches the TD of the URSP rule (see, e.g., event 630 in FIG. 6). At block 940, the UE 102 determines whether to report URSP rules enforcement based on the reporting trigger indication associated with the enforced URSP rule. The flow proceeds to block 941 if the UE 102 determines to report URSP rules enforcement, and to block 943 otherwise.

The UE 102 performs a PDU Session Establishment request procedure at block 941 or block 943 when the PDU session indicated in a Route Selection Descriptor (RSD) does not exist. Further, when the PDU session indicated in the RSD exists, and there is an existing quality-of-service (QoS) flow for accommodating the traffic, the UE 102 at block 941 performs a PDU Session Modification request procedure for reporting the CC for the enforced URSP rule. Still further, when the PDU session indicated in the RSD exists and there is no existing QoS flow for accommodating the traffic, the UE 102 at block 941 performs a PDU Session Modification request procedure for requesting a new QoS flow and reporting the CC for the enforced URSP rule.

At block 941, when the UE 102 detects a reporting trigger indication associated with the enforced URSP rule, the UE 102 includes the connection capabilities, as reporting information, in the PDU Session Establishment/Modification request message (see, e.g., event 641 in FIG. 6), based on the URSP rules the UE 102 receives from the network, or the pre-configured URSP rules when the UE 102 does not receive the URSP rules from the network.

At block 943, when there is no reporting trigger indication associated with the enforced URSP rule, the UE 102 performs a PDU Session Establishment/Modification request procedure without including connection capabilities as a reporting information.

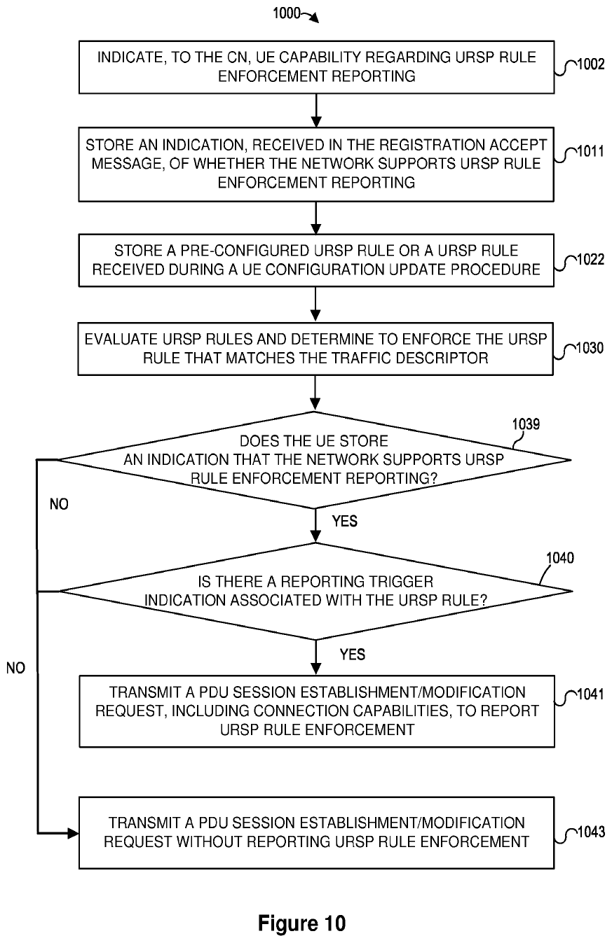

FIG. 10 is a flow diagram of an example method 1000 for reporting URSP rule enforcement based on whether there is a reporting trigger indication for the URSP rule, and whether the CN indicated support of URSP rule enforcement reporting.

Thus, according to the method 1000, the UE 102 reports URSP rules containing the CC if the UE 102 has received (and stored) an indication of support of the CC reporting feature. The UE 102 receives the indication that the URSP rule enforcement reporting from the AMF 364 via a NAS message. The AMF 364 first receives a URSP rule reporting support indication from the PCF-UE, if the PCF-UE supports this feature, and then provides the URSP rule reporting support indication to the UE 102, in a Registration Accept message during the Registration Request procedure.

The method 1000 begins at block 1002, similar to block 902 discussed above. At block 1011, the UE 102 receives a URSP rule reporting support indication in the Registration Accept message in the Registration Request procedure, when the network supports UE reporting of URSP rules enforcement (see, e.g., event 711 in FIG. 7).

Blocks 1022 and 1030 are similar to blocks 922 and 930 discussed above. At block 1039, the UE 102 checks the stored URSP rule reporting support indication to determine whether to the UE 102 should enable reporting of URSP rules enforcement. If yes, the flow proceeds to block UE 1040; otherwise, the flow proceeds to block 1043. Blocks 1040, 1041, and 1043 are similar to blocks 940, 941, and 943, respectively.

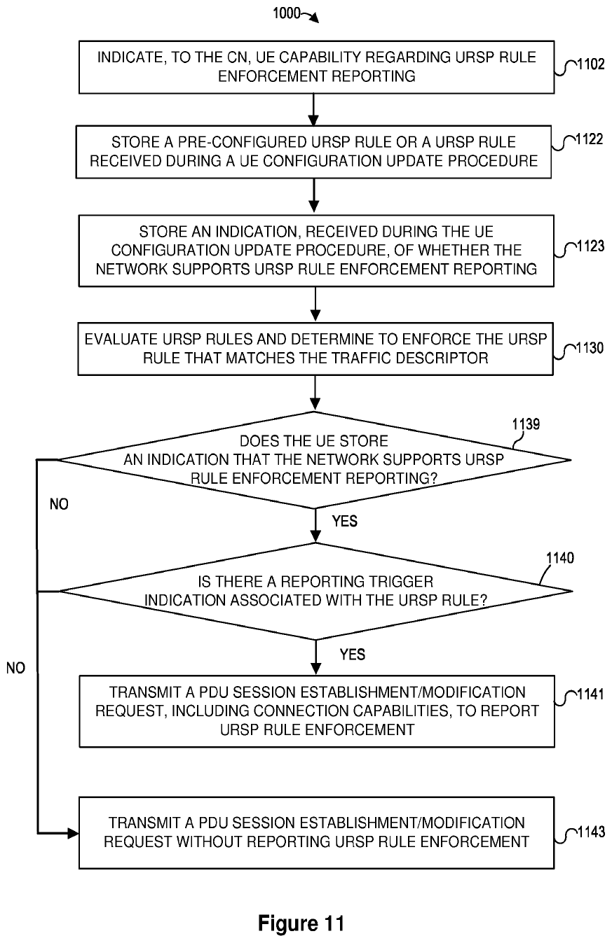

FIG. 11 is a flow diagram of an example method 1100 generally similar to the method 1000, but with the CN 110 indicating support of URSP rule enforcement reporting during a UE configuration update procedure rather than in a registration accept message.

Block 1102 is similar to block 1002, and block 1122 is similar to block 1022. At block 1123, the UE 102 receives URSP rule reporting support indication in the DL NAS Transport message during the UE Configuration Update procedure (see, e.g., event 823 of FIG. 8). The URSP rule reporting support indication in some cases is within the UE policy container, which also includes the UE policy information. The UE 102 receives the URSP rule reporting support indication when the network supports UE reporting URSP rules enforcement. Blocks 1130, 1139, 1140, 1141, and 1143 are similar to blocks 1030, 1039, 1040, 1041, and 1043, respectively.

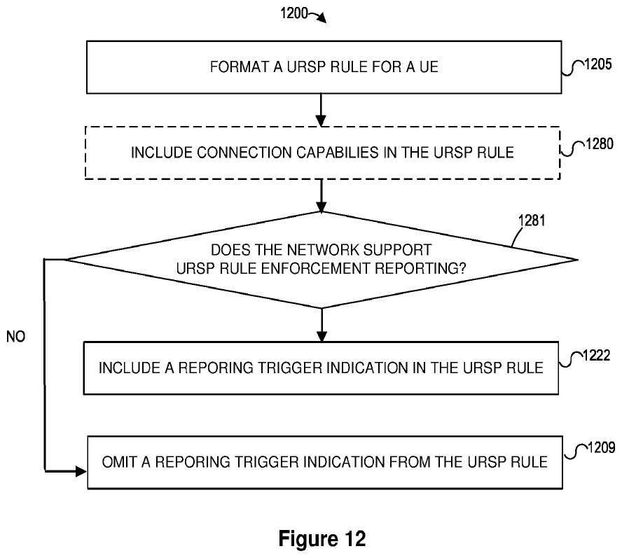

Referring next to FIG. 12, the CN 110 can implement an example method 1200 to configure, for a UE, a URSP rule with an indication of URSP rule enforcement reporting. According to the method 1200, a UE policy container includes UE policy information containing URSP rules, and the URSP rule may include a reporting trigger indication, if connection capabilities is included in a TD.

At block 1205, the CN 110 formats a URSP rule for a UE. Optionally, at block 1280, the CN includes a connection capabilities field in the URSP rule. At block 1281, the CN 110 determines whether the network (e.g., the PCF 360) supports URSP rule enforcement reporting. If yes, the flow proceeds to block 1222, where the CN 110 includes a reporting trigger indication in the URSP rule 110 (see, e.g., event 622 of FIG. 6). Otherwise, the flow proceeds to block 1209, where the CN 110 omits the reporting trigger indication from the URSP rule.

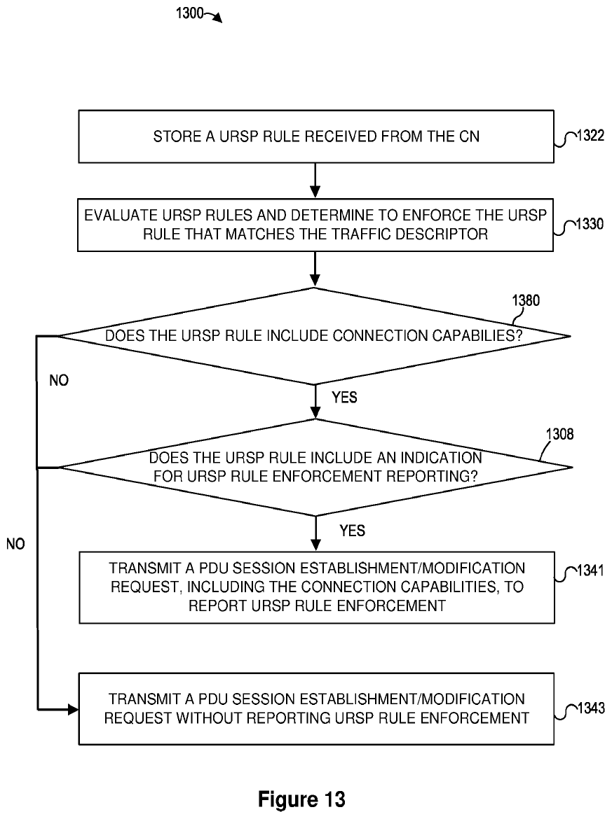

FIG. 13 is a flow diagram of an example method 1300 for processing a URSP rule with an indication of URSP rule enforcement reporting, which can be implemented in the UE 102. The UE 102 can implement the method 1300 when, for example, the CN 110 implements the method 1200.

At block 1322, the UE 102 stores a URSP rule received from the CN 110 (see, e.g., event 622 of FIG. 6). At block 1330, the UE evaluates the URSP rule and determines to enforce the URSP rule that matches the TD (see, e.g., event 630 of FIG. 6). Next, at block 1380, the UE determines whether the URSP rule includes connection capabilities. If yes, the flow proceeds to block 1308, where the UE determines whether the URSP rule includes an indication for URSP rule enforcement reporting, and proceeds to block 1341 if the indication for URSP rule enforcement reporting is present. Otherwise, the flow proceeds to block 1343.

At block 1341, the UE 102 transmits 1341 a PDU Session Establishment/Modification request message including the CC to the CN 110 (see, e.g., event 641 in FIG. 6, event 741 in FIG. 7, block 941 in FIG. 9). At block 1343, the UE 102 transmits a PDU Session Establishment/Modification request message without a CC, or without otherwise reporting URSP rule enforcement (see, e.g., block 943 in FIG. 9).

Thus, according to the methods of FIGS. 12 and 13, the UE 102 reports URSP rules enforcement when (i) the enforced URSP rule includes Connection capabilities in TD, and (ii) the enforced URSP rule includes a reporting trigger indication. The following examples apply to the methods of FIGS. 12 and 13.

For the example rule format A-1, the UE needs to report the enforced URSP rule, which includes an indication for reporting URSP rule enforcement, when the connection capabilities are included in the TD.

Example A-1

| Information | | Value |
|---|---|---|
| name | Description | (example) |
| Rule | Determines the order the URSP | 3 |
| Precedence | rule is enforced in the UE. | |
| Indication for | Determines the reporting the | Included |
| reporting URSP | URSP rule enforced in the UE. | |
| rule enforcement | | |
| Traffic | This part defines the Traffic | |
| descriptor (TD) | descriptor components for the | |
| | URSP rule. | |
| Connection | This is matched against the | “Real time |
| Capabilities | information provided by a UE | interactive” |
| | application when it requests a | |
| | network connection with certain | |
| | capabilities or traffic categories. | |
| Route Selection | A list of Route Selection | |
| Descriptors | Descriptors. The components of | |
| (RSD) | a Route Selection Descriptor. | |
| Route Selection | Determines the order in which | 1 |
| Descriptor | the Route Selection Descriptors | |
| Precedence | are to be applied. | |
| Route selection | This part defines the route | — |
| components | selection components | |
| Network Slice | Either a single value or a list of | S-NSSAI-X |
| Selection | values of S-NSSAI(s). | |
| DNN Selection | Either a single value or a list of | internet |
| | values of DNN(s). | |
| Access Type | Indicates the preferred Access | 3GPP-Access |
| preference | Type (3GPP or non-3GPP or | |
| | Multi-Access) when the UE | |
| | establishes a PDU Session for | |
| | the matching application. | |

For the example rule format B-1, the UE does not need to report the enforced URSP rule because the rule does not include an indication for reporting URSP rule enforcement, even if the connection capabilities are included in the TD.

Example B-1

| Information | | Value |
|---|---|---|
| name | Description | (example) |
| Rule | Determines the order the URSP | 1 |
| Precedence | rule is enforced in the UE. | |
| Traffic | This part defines the Traffic | |
| descriptor (TD) | descriptor components for the | |
| | URSP rule. | |
| Connection | This is matched against the | “Real time |
| Capabilities | information provided by a UE | interactive” |
| | application when it requests a | |
| | network connection with certain | |
| | capabilities or traffic categories. | |
| Route Selection | A list of Route Selection | |
| Descriptors | Descriptors. The components of | |
| (RSD) | a Route Selection Descriptor. | |
| Route Selection | Determines the order in which | 2 |
| Descriptor | the Route Selection Descriptors | |
| Precedence | are to be applied. | |
| Route selection | This part defines the route | |
| components | selection components | |
| Network Slice | Either a single value or a list of | S-NSSAI-X |
| Selection | values of S-NSSAI(s). | |
| DNN Selection | Either a single value or a list of | internet |
| | values of DNN(s). | |
| Access Type | Indicates the preferred Access | 3GPP-Access |
| preference | Type (3GPP or non-3GPP or | |
| | Multi-Access) when the UE | |
| | establishes a PDU Session for | |
| | the matching application. | |

For the example rule format C-1, the UE does not need to report the enforced URSP rule, which includes an indication for reporting URSP rule enforcement but does not include the connection capabilities in the TD.

Example C-1

| Information | | Value |
|---|---|---|
| name | Description | (example) |
| Rule | Determines the order the URSP | 3 |
| Precedence | rule is enforced in the UE. | |
| Indication for | Determines the reporting the | Included |
| reporting URSP | URSP rule enforced in the UE. | |
| rule enforcement | | |
| Traffic | This part defines the Traffic | |
| descriptor (TD) | descriptor components for the | |
| | URSP rule. | |
| Application | It consists of OSId and | App2 |
| descriptors | OSAppId(s). | |
| Route Selection | A list of Route Selection | |
| Descriptors | Descriptors. The components of | |
| (RSDs) | a Route Selection Descriptor. | |
| Route Selection | Determines the order in which | 2 |
| Descriptor | the Route Selection Descriptors | |
| Precedence | are to be applied. | |
| Route selection | This part defines the route | |
| components | selection components | |
| Network Slice | Either a single value or a list of | S-NSSAI-X |
| Selection | values of S-NSSAI(s). | |
| DNN Selection | Either a single value or a list of | internet |
| | values of DNN(s). | |
| Access Type | Indicates the preferred Access | 3GPP-Access |
| preference | Type (3GPP or non-3GPP or | |
| | Multi-Access) when the UE | |
| | establishes a PDU Session for | |
| | the matching application. | |

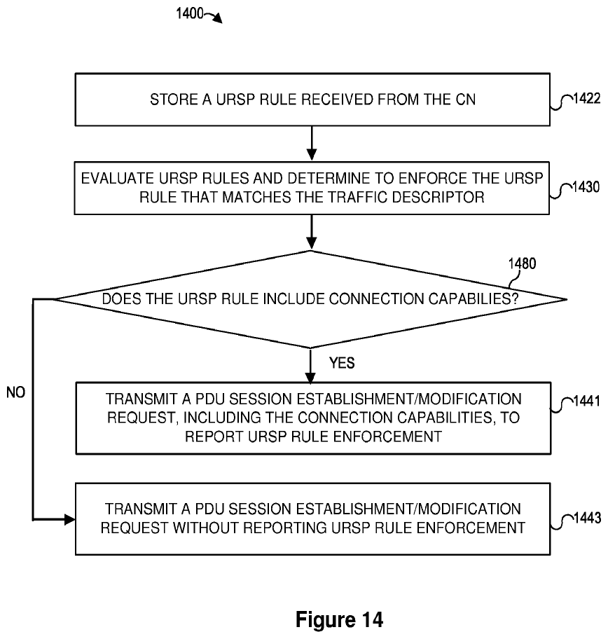

Next, FIG. 14 illustrates an example method 1400 for processing a URSP rule with an implicit indication of URSP rule enforcement reporting, which can be implemented in the UE 102. Blocks 1422 and 1430 are similar to blocks 1322 and 1330 discussed above with reference to FIG. 13. At block 1480, the UE 102 determines whether the URSP includes connection capabilities. If yes, the flow proceeds to block 1441, which is similar to block 1341; otherwise, the flow proceeds to block 1443, which is similar to block 1343.

According to this method, if the UE 102 stores an indication of URSP reporting support, the UE reports URSP rules enforcement when the following condition is fulfilled: the enforced URSP rule includes connection capabilities in the TD.

For the example rule format A-2, the UE needs to report the enforced URSP rule, which includes connection capabilities in the TD.

Example A-2

| Information | | Value |
|---|---|---|
| name | Description | (example) |
| Rule | Determines the order the URSP | 3 |
| Precedence | rule is enforced in the UE. | |
| Traffic | This part defines the Traffic | |
| descriptor | descriptor components for the | |
| (TD) | URSP rule. | |
| Connection | This is matched against the | “Real time |
| Capabilities | information provided by a UE | interactive” |
| | application when it requests a | |
| | network connection with certain | |
| | capabilities or traffic categories. | |
| Route Selection | A list of Route Selection | |
| Descriptors | Descriptors. The components of | |
| (RSD) | a Route Selection Descriptor. | |
| Route Selection | Determines the order in which | 1 |
| Descriptor | the Route Selection Descriptors | |
| Precedence | are to be applied. | |
| Route selection | This part defines the route | — |
| components | selection components | |
| Network Slice | Either a single value or a list | S-NSSAI-X |
| Selection | of values of S-NSSAI(s). | |
| DNN Selection | Either a single value or a list | internet |
| | of values of DNN(s). | |
| Access Type | Indicates the preferred Access | 3GPP-Access |
| preference | Type (3GPP or non-3GPP or | |
| | Multi-Access) when the UE | |
| | establishes a PDU Session for | |
| | the matching application. | |

For the example rule format B-2, the UE does not need to report the enforced URSP rule, which does not include connection capabilities in the TD.

Example B-2

| Information | | Value |
|---|---|---|
| name | Description | (example) |
| Rule | Determines the order the URSP | 3 |
| Precedence | rule is enforced in the UE. | |
| Traffic | This part defines the Traffic | |
| descriptor | descriptor components for the | |
| (TD) | URSP rule. | |
| Application | It consists of OSId and | App2 |
| descriptors | OSAppId(s). | |
| Route Selection | A list of Route Selection | |
| Descriptors | Descriptors. The components of | |
| (RSDs) | a Route Selection Descriptor. | |
| Route Selection | Determines the order in which | 2 |
| Descriptor | the Route Selection Descriptors | |
| Precedence | are to be applied. | |
| Route selection | This part defines the route | |
| components | selection components | |
| Network Slice | Either a single value or a list of | S-NSSAI-X |
| Selection | values of S-NSSAI(s). | |
| DNN Selection | Either a single value or a list of | internet |
| | values of DNN(s). | |
| Access Type | Indicates the preferred Access | 3GPP-Access |
| preference | Type (3GPP or non-3GPP or | |
| | Multi-Access) when the UE | |
| | establishes a PDU Session for | |
| | the matching application. | |

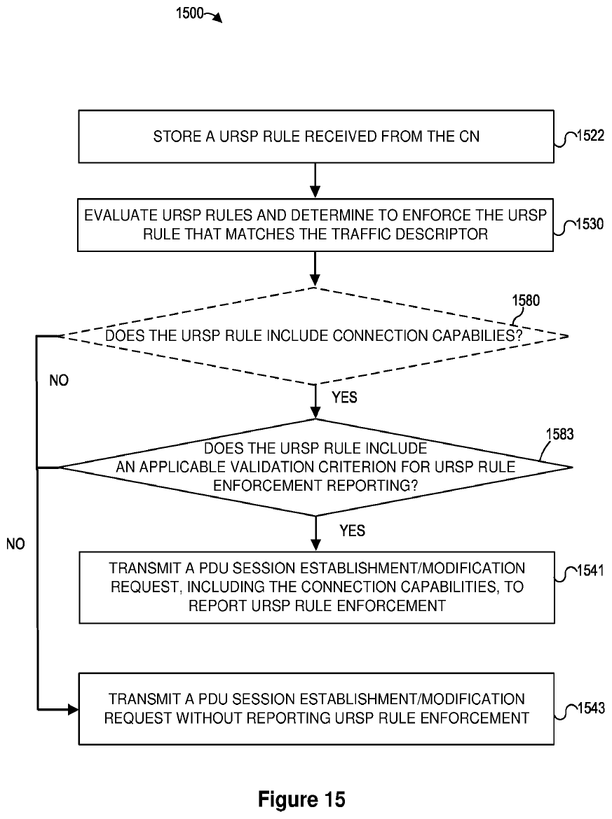

FIG. 15 illustrates an example method 1500 for processing a URSP rule with one or more validation criteria for URSP rule enforcement reporting, which can be implemented in the UE 102 for example. Blocks 1522 and 1530 are similar to blocks 1322 and 1330 discussed above with reference to FIG. 13. The method 1500 optionally can include block 1580, similar to block 1480 discussed above. At block 1583, the UE 102 determines whether the URSP rule includes an applicable validation criterion (e.g., time, location) for URSP rule enforcement reporting. If yes, the flow proceeds to block 1541, which is similar to block 1341; otherwise, the flow proceeds to block 1543, which is similar to block 1343.

According to this method, the UE reports URSP rules enforcement when the following conditions are fulfilled: (i) the enforced URSP rule includes connection capabilities in the TD, and (ii) the validity conditions indicated in the Reporting URSP rule Criteria Descriptor are satisfied. The Reporting URSP rule Criteria Descriptor can include such validity conditions as location criteria or a time window for example, and can be a dedicated descriptor specifically defined for the purpose of specifying conditions for URSP rule enforcement reporting.

For the example rule format A-3, the UE (at Location-A) needs to report the enforced URSP rule based on the matched Reporting URSP rule Criteria, if the connection capabilities are included in the TD.

Example A-3

| Information | | Value |
|---|---|---|
| name | Description | (example) |
| Rule | Determines the order the URSP | 3 |
| Precedence | rule is enforced in the UE. | |
| Indication for | Determines the reporting the | Included |
| reporting URSP | URSP rule enforced in the UE. | |
| rule enforcement | | |
| Traffic | This part defines the Traffic | |
| descriptor (TD) | descriptor components for the | |
| | URSP rule. | |
| Connection | This is matched against the | “Real time |
| Capabilities | information provided by a UE | interactive” |
| | application when it requests a | |
| | network connection with certain | |
| | capabilities or traffic categories. | |
| Route Selection | A list of Route Selection | |
| Descriptors | Descriptors. The components of | |
| (RSD) | a Route Selection Descriptor. | |
| Route Selection | Determines the order in which | 1 |
| Descriptor | the Route Selection Descriptors | |
| Precedence | are to be applied. | |
| Route selection | This part defines the route | — |
| components | selection components | |
| Network Slice | Either a single value or a list | S-NSSAI-X |
| Selection | of values of S-NSSAI(s). | |
| DNN Selection | Either a single value or a list | internet |
| | of values of DNN(s). | |
| Access Type | Indicates the preferred Access | 3GPP-Access |
| preference | Type (3GPP or non-3GPP or | |
| | Multi-Access) when the UE | |
| | establishes a PDU Session for | |
| | the matching application. | |
| Reporting | This part defines the Reporting | |
| URSP rule | URSP rule enforcement | |
| Criteria | Validation Criteria components | |
| Time Window | The time window when the | — |
| | matching traffic is allowed. The | |
| | RSD is not considered to be | |
| | valid if the current time is not | |
| | in the time window. | |
| Location | The UE location where the | Location-A |
| Criteria | matching traffic is allowed. The | |
| | RSD rule is not considered to | |
| | be valid if the UE location does | |
| | not match the location criteria. | |
| Indication for | Determines the reporting the | Included |
| reporting URSP | URSP rule enforced in the UE | |
| rule enforcement | based on indication of URSP | |
| | reporting support stored at | |
| | the UE. | |

For the example rule format B-3, the UE (at 10 am Friday in Location-B) does not need to report the enforced URSP rule based on Reporting URSP rule Criteria, even if the connection capabilities are included in the TD.

Example B-3

| Information | | Value |
|---|---|---|
| name | Description | (example) |
| Rule | Determines the order the URSP | 1 |
| Precedence | rule is enforced in the UE. | |
| Traffic | This part defines the Traffic | |
| descriptor (TD) | descriptor components for the | |
| | URSP rule. | |
| Connection | This is matched against the | “Real time |
| Capabilities | information provided by a UE | interactive” |
| | application when it requests a | |
| | network connection with certain | |
| | capabilities or traffic categories. | |
| Route Selection | A list of Route Selection | |
| Descriptors | Descriptors. The components of | |
| (RSD) | a Route Selection Descriptor. | |
| Route Selection | Determines the order in which | 2 |
| Descriptor | the Route Selection Descriptors | |
| Precedence | are to be applied. | |
| Route selection | This part defines the route | |
| components | selection components | |
| Network Slice | Either a single value or a list | S-NSSAI-X |
| Selection | of values of S-NSSAI(s). | |
| DNN Selection | Either a single value or a list | internet |
| | of values of DNN(s). | |
| Access Type | Indicates the preferred Access | 3GPP-Access |
| preference | Type (3GPP or non-3GPP or | |
| | Multi-Access) when the UE | |
| | establishes a PDU Session for | |
| | the matching application. | |
| Reporting | This part defines the Reporting | |
| URSP rule | URSP rule enforcement | |
| Criteria | Validation Criteria components | |
| Time Window | The time window when the | 9 am-5 pm, |
| | matching traffic is allowed. The | Friday |
| | RSD is not considered to be | |
| | valid if the current time is not | |
| | in the time window. | |
| Location | The UE location where the | Location-A |
| Criteria | matching traffic is allowed. The | |
| | RSD rule is not considered to | |
| | be valid if the UE location does | |
| | not match the location criteria. | |

For the example rule format C-3, the UE (at 10 am Friday in Location-A) does not need to report the enforced URSP rule, which does not include connection capabilities in the TD, even if the current time matches the time window, and the current location matches the location criteria indicated in the Reporting URSP rule Criteria.

Example C-3

| Information | | Value |
|---|---|---|
| name | Description | (example) |
| Rule | Determines the order the URSP | 3 |
| Precedence | rule is enforced in the UE. | |
| Traffic | This part defines the Traffic | |
| descriptor | descriptor components for the | |
| (TD) | URSP rule. | |
| Application | It consists of OSId and | App2 |
| descriptors | OSAppId(s). | |
| Route Selection | A list of Route Selection | |
| Descriptors | Descriptors. The components of | |
| (RSDs) | a Route Selection Descriptor. | |
| Route Selection | Determines the order in which | 2 |
| Descriptor | the Route Selection Descriptors | |
| Precedence | are to be applied. | |
| Route selection | This part defines the route | |
| components | selection components | |
| Network Slice | Either a single value or a list | S-NSSAI-X |
| Selection | of values of S-NSSAI(s). | |
| DNN Selection | Either a single value or a list | internet |
| | of values of DNN(s). | |
| Access Type | Indicates the preferred Access | 3GPP-Access |
| preference | Type (3GPP or non-3GPP or | |
| | Multi-Access) when the UE | |
| | establishes a PDU Session for | |
| | the matching application. | |
| Reporting | This part defines the Reporting | |
| URSP rule | URSP rule enforcement | |
| Criteria | Validation Criteria components | |
| Time Window | The time window when the | 9 am-5 pm, |
| | matching traffic is allowed. The | Friday |
| | RSD is not considered to be | |
| | valid if the current time is not | |
| | in the time window. | |
| Location | The UE location where the | Location-A |
| Criteria | matching traffic is allowed. The | |
| | RSD rule is not considered to | |
| | be valid if the UE location does | |
| | not match the location criteria. | |

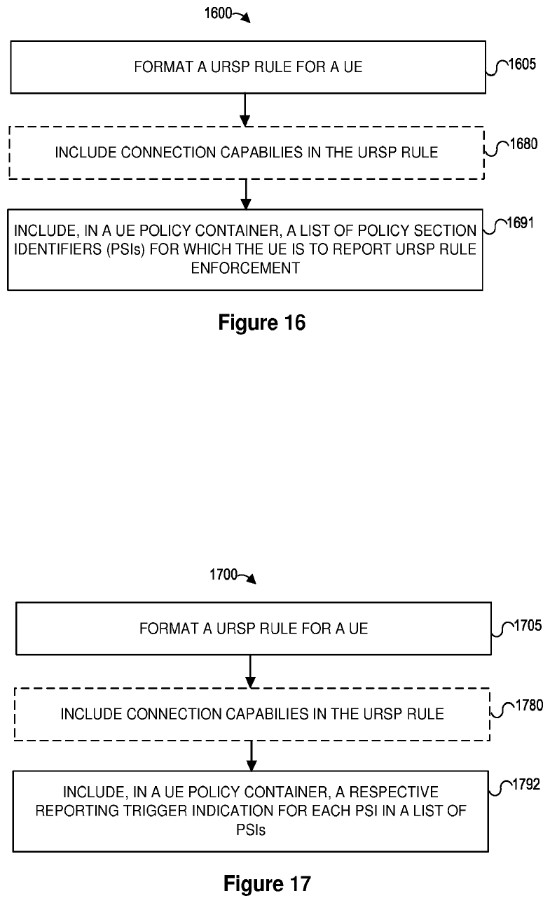

Next, FIG. 16 illustrates an example method 1600 for providing a list of Policy Section Identifiers (PSIs) for which the UE is to perform URSP rule enforcement reporting, which can be implemented in the CN 110 for example. At block 1605, the CN 110 formats a URSP rule for a UE. Optionally, at block 1680, the CN includes a connection capabilities field in the URSP rule. At block 1691, the CN 110 includes, in a UE policy container, a list of PSIs for which the UE 102 is to report URSP rule enforcement.

FIG. 17 illustrates an example method 1700 for specifying URSP rule reporting for individual PSIs, which can be implemented in the CN 110. Blocks 1705 and 1780 are similar to blocks 1605 and 1680 discussed above. At block 1792, the CN 110 includes, in a UE policy container, a reporting trigger indication for each PSI included in the list of PSIs. Thus, unlike the method 1600, the CN 110 includes a reporting trigger as a respective parameter of each PSI.

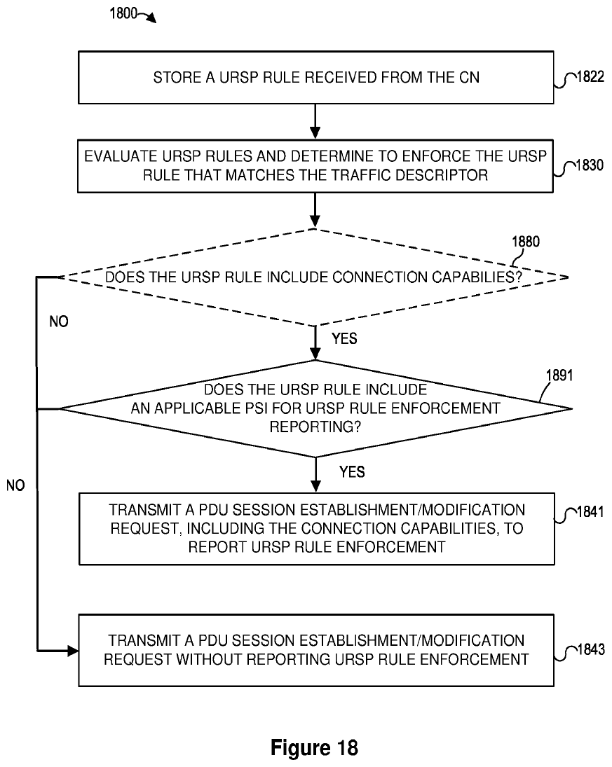

FIG. 18 is a flow diagram of an example method for determining whether to report URSP rule enforcement based on a PSI, which the UE 102 or another suitable UE can implement when the CN 110 implements the method 1600 or 1700. Blocks 1822 and 1830 are similar to blocks 1322 and 1330 discussed above with reference to FIG. 13, for example. At block 1880, the UE determines whether the URSP rule includes connection capabilities. If yes, the flow proceeds to block 1841, which is similar to block 1341; otherwise, the flow proceeds to block 1843, which is similar to block 1343.

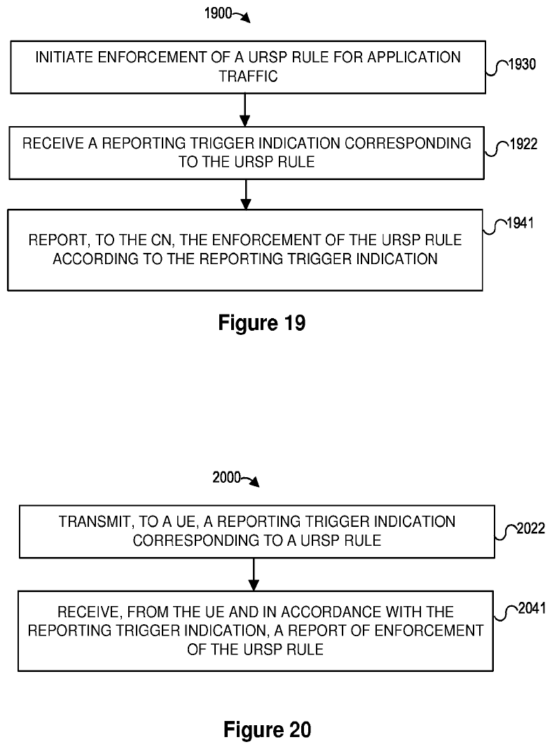

FIG. 19 is a flow diagram of an example method for processing application traffic, which can be implemented in a UE such as the UE 102. At block 1930, the UE 102 initiates enforcement of a URSP rule for application traffic (see, e.g., event 630 in FIG. 6, event 730 of FIG. 7, event 830 of FIG. 8, block 930 of FIG. 9, block 1030 in FIG. 10, block 1130 in FIG. 11, block 1330 in FIG. 13, block 1430 in FIG. 14, block 1530 in FIG. 15, block 1830 in FIG. 18). At block 1922, the UE receives a reporting trigger indication corresponding to the URSP rule (see, e.g., event 622 in FIG. 6, event 722 in FIG. 7, event 823 in FIG. 8, block 922 in FIG. 9, block 1039 in FIG. 10, block 1139 in FIG. 11, block 1380 in FIG. 13, block 1480 in FIG. 14, block 1583 in FIG. 15, block 1891 in FIG. 18). At block 1941, the UE reports, to the CN, the enforcement of the URSP rule according to the reporting trigger indication (see, e.g., event 641 in FIG. 6, event 741 of FIG. 7, event 841 of FIG. 8, block 941 of FIG. 9, block 1041 in FIG. 10, block 1141 in FIG. 11, block 1341 in FIG. 13, block 1441 in FIG. 14, block 1541 in FIG. 15, block 1841 in FIG. 18).

FIG. 20 is a flow diagram of an example method 2000 for routing application traffic, which can be implemented in the CN 110 or another suitable CN. At block 2022, the CN transmits, to a UE, a reporting trigger indication corresponding to a URSP rule (see, e.g., event 622 in FIG. 6, event 722 in FIG. 7, event 823 in FIG. 8, block 922 in FIG. 9, block 1039 in FIG. 10, block 1139 in FIG. 11, block 1380 in FIG. 13, block 1480 in FIG. 14, block 1583 in FIG. 15, block 1691 in FIG. 16, block 1792 in FIG. 17). At block 2041, the CN 110 receives, from the UE and in accordance with the reporting trigger indication, a report of enforcement of the URSP rule (see, e.g., event 641 in FIG. 6, event 741 of FIG. 7, event 841 of FIG. 8, block 941 of FIG. 9, block 1041 in FIG. 10, block 1141 in FIG. 11, block 1341 in FIG. 13, block 1441 in FIG. 14, block 1541 in FIG. 15, block 1841 in FIG. 18).

The following list of examples reflects a variety of the embodiments explicitly contemplated by the present disclosure:

Example 1. A method for routing application traffic, the method implemented in a user equipment (UE) and comprising: initiating, for the application traffic, an enforcement of a UE route selection policy (URSP) rule; receiving, from a core network (CN), a reporting trigger indication corresponding to the URSP rule; and reporting, to the CN and in accordance with the reporting trigger indication, the enforcement of the URSP rule.

Example 2. The method of example 1, wherein the reporting is in response to determining that the CN supports the reporting, by the UE, of the enforcement of the URSP rule.

Example 3. The method of example 2, further comprising receiving a network reporting support indication indicating that the CN supports the reporting of the enforcement of the URSP rule from the CN.

Example 4. The method of example 3, wherein the network reporting support indication is included in a registration accept message.

Example 5. The method of example 3, wherein the network reporting indication is included in a downlink (DL) non-access stratum (NAS) transport message.

Example 6. The method of example 5, wherein the network reporting support indication is included in a UE policy container, in the DL NAS transport message.

Example 7. The method of example 6, wherein the reporting trigger indication is included in the UE policy container.

Example 8. The method of example 5, wherein the network reporting support indication is a first information element (IE) of the DL NAS transport message, and a UE policy container is a second IE of the DL NAS transport message.

Example 9. The method of any of examples 3-8, wherein the network reporting support indication is received during a UE configuration update procedure initiated by the CN.

Example 10. The method of any of examples 2-9, wherein the determining that the CN supports the reporting includes determining that a Policy Control Function (PCF) operating in the CN supports the reporting.

Example 11. The method of example 7, wherein the UE policy container is included in a downlink (DL) non-access stratum (NAS) transport message.

Example 12. The method of any of examples 1-6, wherein the reporting trigger indication is included in the URSP rule.

Example 13. The method of example 12, wherein the reporting trigger indication is a dedicated IE of the URSP rule.

Example 14. The method of example 12, wherein: the reporting of the enforcement of the URSP rule is in response to determining that the URSP rule includes (i) the reporting trigger indication and (ii) a connection capabilities (CC) field.

Example 15. The method of example 12, wherein the reporting of the enforcement of the URSP rule is in response to determining that the URSP rule includes a CC field.

Example 16. The method of example 12, wherein the reporting trigger indication is included as a validity condition in a listing of reporting URSRP rule criteria, in the URSP rule.

Example 17. The method of example 16, wherein the validity condition is associated with location and/or time.

Example 18. The method of any of examples 1-5, wherein: the reporting of the enforcement of the URSP rule is in response to determining that the URSP rule is associated with a certain Policy Section Identifier (PSI).

Example 19. The method of example 18, wherein the PSI is included in a UE policy container.

Example 20. The method of any of the preceding examples, wherein the reporting of the enforcement is during a PDU Session Modification request procedure.

Example 21. The method of any of the preceding examples, further comprising transmitting, to the CN, an indication of a capability of the UE to report the enforcement

Example 22. The method of example 21, wherein the indication of the capability is transmitted in a Registration Request message.

Example 23. The method of any of the preceding examples, further comprising receiving the URSP rule from the CN.

Example 24. The method of any of examples 1-22, further comprising retrieving the URSP rule from a local memory in which the URSP rule is preconfigured.

Example 25. A method for routing application traffic, the method implemented in a core network (CN) of a cellular communication system and comprising: transmitting, to a user equipment (UE), a reporting trigger indication corresponding to a UE route selection policy (URSP) rule stored at the UE; and receiving, from the UE and in accordance with the reporting trigger indication, a report of enforcement of the URSP rule.

Example 26. The method of example 25, further comprising transmitting, to the UE, a network reporting support indication indicating that the CN supports the report of the enforcement of the URSP rule.

Example 27. The method of example 26, wherein the network reporting support indication is included in a registration accept message.

Example 28. The method of example 26, wherein the network reporting support indication is included in a downlink (DL) non-access stratum (NAS) transport message.

Example 29. The method of example 28, wherein the network reporting support indication is included in a UE policy container, in the DL NAS transport message.

Example 30. The method of example 28, wherein the network reporting support indication is a first information element (IE) of the DL NAS transport message, and a UE policy container is a second IE of the DL NAS transport message.

Example 31. The method of any of examples 26-30, wherein the network reporting support indication is received during a UE configuration update procedure initiated by the CN.

Example 32. The method of any of examples 25-28, wherein the reporting trigger indication is included in a UE policy container.

Example 33. The method of example 32, wherein the UE policy container is included in a downlink (DL) non-access stratum (NAS) transport message.

Example 34. The method of example 30, wherein the reporting trigger indication is included in the UE policy container.

Example 35. The method of any of examples 25-31, wherein the reporting trigger indication is included in the URSP rule.

Example 36. The method of example 35, wherein the reporting trigger indication is a dedicated IE of the URSP rule.

Example 37. The method of example 35, wherein the reporting of the enforcement of the URSP rule is in response to determining that the URSP rule includes (i) the reporting trigger indication and (ii) a connection capabilities (CC) field.

Example 38. The method of example 35, wherein the reporting of the enforcement of the URSP rule is in response to determining that the URSP rule includes a CC field.

Example 39. The method of example 35, wherein the reporting trigger indication is included as a validity condition in a listing of reporting URSRP rule criteria, in the URSP rule.

Example 40. The method of example 39, wherein the validity condition is associated with location and/or time.

Example 42. A device comprising processing hardware and configured to implement a method of any of the preceding claims.

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present)

When implemented in software, the techniques can be provided as part of the operating system, a library used by multiple applications, a particular software application, etc. The software can be executed by one or more general-purpose processors or one or more special-purpose processors.

1. A method for routing application traffic, the method implemented in a user equipment (UE) and comprising:
initiating, for the application traffic, an enforcement of a UE route selection policy (URSP) rule;
receiving, from a core network (CN), a reporting trigger indication corresponding to the URSP rule; and
reporting, to the CN and in accordance with the reporting trigger indication, the enforcement of the URSP rule.

2. The method of claim 1, wherein:
the reporting is in response to determining that the CN supports the reporting, by the UE, of the enforcement of the URSP rule.

3. The method of claim 2, further comprising:
receiving a network reporting support indication indicating that the CN supports the reporting of the enforcement of the URSP rule from the CN.

4. The method of claim 3, wherein:
the network reporting support indication is included in a registration accept message.

5. The method of claim 3, wherein:
the network reporting support indication is included in a UE policy container, in the DL NAS transport message.

6. The method of claim 1, wherein:
the reporting trigger indication is included in a UE policy container.

7. The method of claim 1, wherein:
the reporting trigger indication is included in the URSP rule.

8. The method of claim 7, wherein:
the reporting of the enforcement of the URSP rule is in response to determining that the URSP rule includes (i) the reporting trigger indication and (ii) a connection capabilities (CC) field.

9. The method of claim 1, wherein:
the reporting trigger indication is included as a validity condition in a listing of reporting URSRP rule criteria, in the URSP rule.

10. The method of claim 1, further comprising:
the reporting of the enforcement of the URSP rule is in response to determining that the URSP rule is associated with a certain Policy Section Identifier (PSI).

11. The method of claim 1, wherein:
the reporting of the enforcement is during a PDU Session Modification request procedure.

12. The method of claim 1, further comprising:
transmitting, to the CN, an indication of a capability of the UE to report the enforcement.

13. The method of example 12, wherein:
the indication of the capability is transmitted in a Registration Request message.

14. A method for routing application traffic, the method implemented in a core network (CN) of a cellular communication system and comprising:
transmitting, to a user equipment (UE), a reporting trigger indication corresponding to a UE route selection policy (URSP) rule stored at the UE; and
receiving, from the UE and in accordance with the reporting trigger indication, a report of enforcement of the URSP rule.

15. The method of claim 14, further comprising:
transmitting, to the UE, a network reporting support indication indicating that the CN supports the report of the enforcement of the URSP rule.

16. (canceled)

17. The method of claim 14, wherein:
the reporting trigger indication is included in a UE policy container.

18. The method of claim 14, wherein:
the reporting trigger indication is included in the URSP rule.

19. The method of claim 18, wherein:
the reporting trigger indication is a dedicated IE of the URSP rule.

20. The method of example 18, wherein:
the reporting of the enforcement of the URSP rule is in response to determining that the URSP rule includes (i) the reporting trigger indication and (ii) a connection capabilities (CC) field.

21. (canceled)

22. A user equipment (UE) comprising processing hardware and configured to route application traffic by:
initiating, for the application traffic, an enforcement of a UE route selection policy (URSP) rule;
receiving, from a core network (CN), a reporting trigger indication corresponding to the URSP rule; and
reporting, to the CN and in accordance with the reporting trigger indication, the enforcement of the URSP rule.
